(19) United States
(12) Patent Application Publication
(10) Pub. No.: US 2019/0356166 A1
(43) Pub. Date: Nov. 21, 2019

(54) Powering/Charging of Medical Simulator Via Induction Technology

(71) Applicant: KbPort LLC, Pittsburgh, PA (US)

(72) Inventors: Adam Christopher Hellein, Pittsburgh, PA (US); Alexander Robert Thomson, Pittsburgh, PA (US); Jerry Woods, Pittsburgh, PA (US)

(21) Appl. No.: 16/410,455

(22) Filed: May 13, 2019

Related U.S. Application Data
(60) Provisional application No. 62/672,121, filed on May 16, 2018.

(51) Int. Cl. H02J 50/10; H02J 7/02; G09B 23/32

(52) U.S. Cl. CPC H02J 50/10; G09B 23/32; H02J 7/025

(57) ABSTRACT

Embodiments relate to a medical simulator system configured to be powered and/or charged via induction technology. The medical simulator system includes a medical simulator having a simulator induction coil in connection with electrical circuitry and/or a power supply. The system also includes a charging station induction coil. The charging station may be stationary or mobile. When the simulator induction coil is placed proximate the charging station induction coil, or vice versa, inductive coupling causes a voltage to be generated in the simulator induction coil. This voltage is used to provide electrical power to the electrical circuitry and/or charge the power supply.

### CROSS-REFERENCE TO RELATED APPLICATIONS

This application is related to and claims the benefit of U.S. Provisional Application No. 62/672,121, filed on May 16, 2018, the entire contents of which are incorporated herein by reference in their entirety.

### FIELD OF THE INVENTION

Embodiments relate to a medical simulator system configured to be powered and/or charged via induction charging.

### BACKGROUND OF THE INVENTION

High fidelity medical simulators can require significant battery units or other power supplies to operate the internal electronics used to produce simulated biological functions. Currently, the batteries are powered/charged through the use of electrical power cords, cables and/or other wires being routed to and from the manikin model of the simulator. The presence of such cords and cables can degrade the fidelity of the simulation, and can restrict the ability to handle the manikin model unless physical accommodations are made for the power cabling. Even with physical accommodations being made, restrictions can often still result.

Conventional medical simulator systems are limited in that they require use of electrical power cords, cables, and other wires to obtain the electrical power needed for operation. This reduces the fidelity of the simulation, complicates the methods for charging and powering, presents an unsafe environment (e.g., electrical power cords can be a tripping hazard), and clutters the area of operation for trainees working with the medical simulator.

The present invention is directed at overcoming one or more of the above-mentioned problems.

### SUMMARY OF THE INVENTION

Embodiments relate to a medical simulator system configured to be powered and/or charged via induction technology. In one embodiment, the medical simulator system includes a medical simulator (e.g., manikin) having a simulator induction coil in connection with electrical circuitry. The system also includes a charging station induction coil. When the simulator induction coil is placed proximate the charging station induction coil, inductive coupling causes a voltage to be generated in the simulator induction coil. This voltage is used to provide electrical power to the electrical circuitry and to power and/or charge the batteries.

In one embodiment, a medical simulator system includes a medical manikin simulator. The medical manikin simulator includes electrical circuitry configured to coordinate concerted motion and functionality of the medical manikin simulator. The medical manikin simulator includes a first power supply in electrical connection with the electrical circuitry. The medical manikin simulator includes a first induction coil in an electrical circuit with the electrical circuitry and/or the first power supply. The medical simulator system includes a second induction coil, separate from the medical manikin simulator, configured to receive electrical current from a second power supply. Inductive coupling between the first induction coil and the second induction coil generates a voltage in the first induction coil to drive the electrical circuitry and/or charge the first power supply when the first induction coil is placed proximate the second induction coil.

In some embodiments, the first power supply is a battery. In some embodiments, the second power supply is configured to provide direct current. Some embodiments include a power inverter to convert the direct current to alternating current. In some embodiments, the second power supply is configured to provide alternating current. Some embodiments include a rectifier to convert alternating current from the first induction coil to direct current. In some embodiments, the medical manikin simulator comprises a body portion having a torso, buttocks, a chest, and a back. In some embodiments, the first induction coil is located at or near the buttocks and/or the back. In some embodiments, the second induction coil is providing within a mobile housing.

In one embodiment, a medical simulator system kit includes at least one a medical manikin simulator, comprising: electrical circuitry configured to coordinate concerted motion and functionality of the medical manikin simulator; a first power supply in electrical connection with the electrical circuitry; and a first induction coil in an electrical circuit with the electrical circuitry and/or the first power supply. The medical simulator system kit includes at least one charging station, comprising: a support structure; and a second induction coil provided within the support structure configured to receive electrical current from a second power supply. The at least one medical manikin simulator is configured to be supported by the at least one charging station so as to facilitate inductive coupling between the first induction coil and the second induction coil generating a voltage in the first induction coil to drive the electrical circuitry and/or charge the first power supply when the medical manikin simulator is supported by the at least one charging station.

In some embodiments, the support structure comprises at least one of a mat, a table, and a workbench. In some embodiments: the at least one medical manikin simulator comprises a first medical manikin simulator and a second medical manikin simulator, the first medical manikin simulator being different from the second medical manikin simulator; the at least one charting station is capable of facilitating inductive coupling between: the first induction coil of the first medical manikin simulator and the second induction coil; and the first induction coil of the second medical manikin simulator and the second induction coil.

In one embodiment, a method of powering and/or charging a medical simulator involves placing a medical manikin simulator proximate a charging station, the medical manikin simulator comprising a first induction coil, a first power supply, and electrical circuitry, the charging station comprising a second induction coil configured to receive electrical current from a second power supply. The method involves inducing inductive coupling between the first induction coil and the second induction coil to generate a voltage for driving the electrical circuitry and/or charging the first power supply.

Some embodiments involve placing the medical manikin simulator on top of the charging station. Some embodiments involve: placing the medical manikin simulator in a first position; and moving the medical manikin simulator to a second position without interruption of the voltage used to drive the circuitry and without accommodating electrical power cables; wherein each of the first position and the second position comprises any one of a prone position, a supine position, a fetal position, or a recovery position, wherein the first position is different from the second position. Some embodiments involve moving at least one appendage of the medical manikin simulator without interruption of the voltage used to drive the circuitry and without accommodating electrical power cables. Some embodiments involve a medical trainee and/or a medical trainer moving about the medical manikin simulator without interruption of the voltage used to drive the circuitry and without accommodating electrical power cables. Some embodiments involve: inducing inductive coupling between the first induction coil of the medical manikin simulator and a second induction coil of a first charging station; moving the medical manikin simulator from the first charging station to a second charging station; and inducing inductive coupling between the first induction coil of the medical manikin simulator and a second induction coil of the second charging station without disconnecting and/or connecting electrical power cables.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 shows an embodiment of the medical simulator system.

FIG. 2 shows another embodiment of the medical simulator system with a charging station configured as a mat, table, or a workbench.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

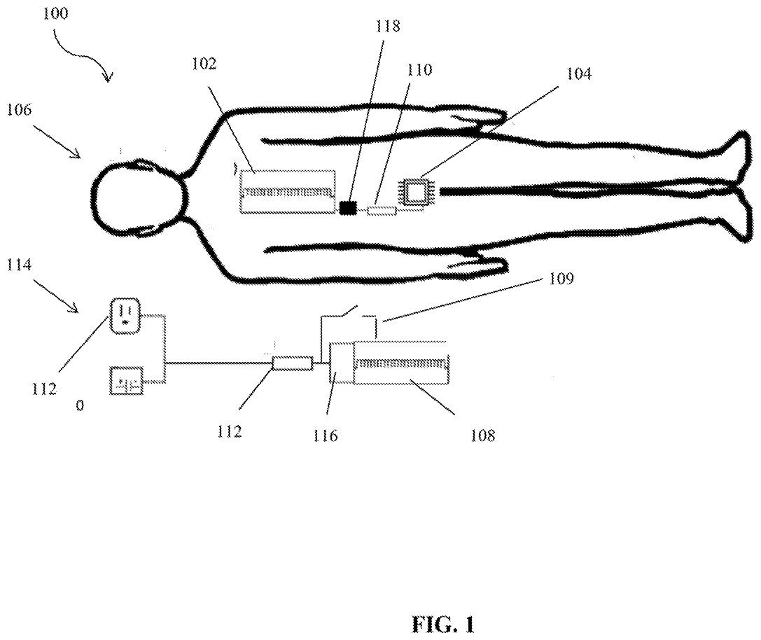

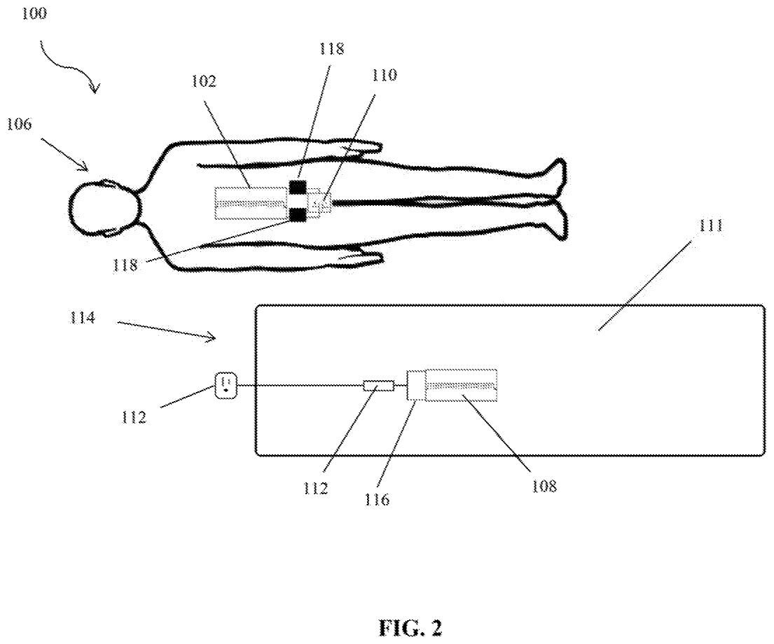

Referring to FIGS. 1-2, embodiments relate to a medical simulator system 100 configured to be powered and/or charged via induction technology. In one embodiment, the medical simulator system 100 includes a medical manikin simulator 106 having a simulator induction coil 102 in connection with electrical circuitry 104 of the medical manikin simulator 106 via a first power supply 110. The system 100 also includes a charging station induction coil 108. When the simulator induction coil 102 is placed proximate the charging station induction coil 108, inductive coupling causes a voltage to be generated in the simulator induction coil 102. This voltage is used to provide electrical power to the electrical circuitry 104 and/or charge the first power supply 110. For example, the charging station induction coil 108 can be connected to an electrical power supply configured to provide an alternating current. As the alternating current travels through the charging station induction coil 108, electromotive forces are generated in the simulator induction coil 102. The simulator induction coil 102, being in an electrical circuit with the electrical circuitry 104, generates the voltage from the electromotive forces to drive the electrical circuitry 104 and/or charge the first power supply 110.

Some embodiments of the system 100 include a medical manikin simulator 106. The medical manikin simulator 106 can be a device configured to resemble the whole or at least a portion of a human anatomy (e.g., a head, a bust, a torso, a back, a respiratory system, a vascular system, etc.). In at least one embodiment, the medical manikin simulator 106 is configured to resemble the entire body of a human. This can include a body portion having a torso, buttocks, a chest, and a back. The medical manikin simulator 106 can have appendages, such as legs and arms. The medical manikin simulator 106 can also have a head. Other features, such as eyes, a heart, liver, intestine, lungs, etc. can also be included. In some embodiment, the medical manikin simulator 106 has animated parts (e.g., head, mouth, legs, arms, fingers, eyelids, eyes, etc.), and is configured to generate physiological movements and physiological conditions. This can be achieved via electrical components (e.g., processors, integrated circuits, switches, display units, sensors, etc.), included within the electrical circuitry 104 and/or mechanical components (e.g., actuators, pumps, motors, etc.) in connection with each other.

The medical manikin simulator 106 has electrical circuitry 104 configured to coordinate concerted motion and functionality of components of the medical manikin simulator 106. The electrical circuitry 104 includes at least one processor in operative association with at least one non-transitory and non-volatile memory. In some embodiments, the first power supply 110, such as a battery, is configured to provide electrical power to the electrical circuitry 104 and/or components of the medical manikin simulator 106. The first power supply 110 can be referred to as a simulator power supply 110.

The medical manikin simulator 106 has a first induction coil 102. The first induction coil 102 can be incorporated (e.g., a unit that is permanently installed) with the medical manikin simulator 106 or attachable (e.g., a unit that is able to be removed or replaced) to the medical manikin simulator 106. The first induction coil 102 can be placed within an interior of the simulator 106 or attached to an outer surface of the simulator 106. The first induction coil 102 is configured to be in connection with the first power supply 110 and/or the electrical circuitry 104. The first induction coil 102 can be referred to as a simulator induction coil 102.

The system 100 includes a second induction coil 108. The second induction coil 108 is configured to be connected to a second power supply 112. The second power supply 112 can be configured to provide alternating electrical current (e.g., the second power supply 112 is a 110 volt-alternating current (V-AC) power outlet or a 220 V-AC power outlet) or direct current (e.g., the second power supply 112 is a battery). In some embodiments, the second induction coil 108 and associated components are configured as a charging station 114. For example, the medical manikin simulator 106 can be located proximate the second induction coil 108 (e.g., placed on top of it) to facilitate inductive coupling between the first induction coil 102 and the second induction coil 108. In some embodiments, the charging station 114 can be configured as support structure 111 (e.g., a table, a mat, a workbench, etc.) configured to support the medical manikin simulator 106. (See FIG. 2). For example, the medical manikin simulator 106 can be placed on top of the charging station 114 and be supported by the charging station 114 as the charging station 114 facilitates electrical power transfer from the second induction coil 108 to the first induction coil 102. The second induction coil 108 can be incorporated (e.g., a unit that is permanently installed) with the support structure 111 or attachable (e.g., a unit that is able to be removed or replaced) to the support structure 111. The second induction coil 108 can be placed within an interior of the support structure 111 or attached to an outer surface of the support structure 111. The second induction coil 108 can be referred to as a charging station induction coil 108.

The charging station 114 (or a portion thereof—e.g., a charging station induction coil 108) can be a mobile device that is taken to or proximate the manikin simulator 106. This is particularly advantageous when it is difficult to move the manikin simulator 106.

In some embodiments, the second induction coil 108 includes a power inverter 116 configured to convert direct current to alternating current. For example, if the second power supply 112 is configured to provide direct current, the power inverter 116 is used to generate an alternating current from the direct current. The alternating current is then routed through the second induction coil 108 to facilitate generating the electromotive forces in a first induction coil 102 that is placed proximate thereto. A relay switch 109 can be used to route electrical current from the second power supply 112 to the second induction coil 108 via the power inverter 116 if the electrical power being supplied by the second power supply 112 is direct current. The relay switch 109 is used to route electrical current from the second power supply 112 to the second induction coil 108, bypassing the power inverter 116, if the electrical power being supplied by the second power supply 112 is alternating current.

In some embodiments, the first induction coil 102 includes a rectifier 118 configured to convert alternating current to direct current. For example, if the electrical power being generated by the first induction coil 102 is being transferred to the first power supply 110, the rectifier 118 is used to generate direct current from the alternating current. The direct current is then routed to the first power supply 110. A relay switch 109 is used to route electrical current from the first induction coil 102 to the first power supply 110 via the rectifier 118 if the electrical current, or at least a portion of it, is being sent to the first power supply 110. The electrical current can then be sent to the electrical circuitry 104 from the first power supply 110. In addition, or in the alternative, the relay switch 109 is used to route electrical current from the first induction coil 102 to the electrical circuitry 104, bypassing the rectifier 118, if the electrical current, or at least a portion of it, is being sent to the electrical circuitry 104. It should be noted that some electrical components and/or mechanical components may operate on direct current. Thus, the relay switch 109 can be configured to route electrical current from the first induction coil 102, through the rectifier 118, and to the electrical circuitry 104, even if the electrical current does not pass through the first power supply 110.

In some embodiments, the system 100 can be used as a kit. The kit includes at least one medical manikin simulator 106 and at least one charging station 114. The kit or any portion of it can be portable so as to move the kit, or a portion of it, to a desired training location. The medical manikin simulator 106 of one kit can be used or interchanged with a medical manikin simulator 106 of another kit. Similarly, the charging station 114 of one kit can be used or interchanged with a charging station 114 of another kit. For example, a first kit may include a first medical manikin simulator 106 and a second kit may include a second medical manikin simulator 106. The first medical manikin simulator 106 may be the same as or different from the second medical manikin simulator 106. As a non-limiting example, the first medical manikin simulator 106 might be configured to provide respiratory training, while the second medical manikin simulator 106 might be configured to provide vascular training. Yet, the first medical manikin simulator 106 and/or the second medical manikin simulator 106 can be configured to operate with any charging station 114. This may allow medical trainers to set up training stations, each training station having a charging station 114. Medical manikin simulators 106 can be moved from training station to training station (as opposed to medical trainees moving from training station to training station) to provide desired training at each station. This may be helpful in classroom setting, where it is easier to move the medical simulators 106 than have pluralities of students moving in and out of classrooms. It should be noted that the medical manikin simulators 106 can be moved without the need to disconnect and re-connect electrical power cables and other wires. Instead, the simulator 106 can be transported from one training station (or charging station 114) to the next and receive electrical power at each charging station 114 without connecting the simulator 106 to electrical power cables. This greatly simplifies the method of charging and powering the simulator 106.

It is contemplated for the first induction coil 102 to be located within, or attached to, the buttocks region or back region of the medical manikin simulator 106; however, the first induction coil 102 can be located at any location in or on the simulator 106. This may be done to maximize the inductive coupling that will occur between the first induction coil 102 and the second induction coil 108 while the simulator 106 is used for training. For example, the simulator 106 may be expected to be used as it is laid on a surface (e.g., a charging station 114) so that the simulator 106 is in a prone, a supine, a fetal, and/or a recovery position. It may also be expected for a medical trainee or medical trainer to move the simulator 106 so as to change its position. Placing the first induction coil 102 at or near the buttock or back region can allow for adequate and effective inductive coupling between the first induction coil 102 of the simulator 106 and the second induction coil 108 of the charging station 114, regardless of the position the simulator 106. It may also be expected for the medical trainer and/or medical trainee to move the appendages and other parts of the simulator 106, and may also be expected for the medical trainer and/or medical trainee to move about the simulator 106 during training. Any one or all of these activities (e.g., positioning/repositioned the simulator 106, moving simulator 106 appendages, movement of the trainee or trainer about the simulator 106, etc.) can be done without having to accommodate electrical power cables and/or disconnecting and re-connecting them. This increases the fidelity of the simulation, reduces clutter, and provides a safe working environment.

In an exemplary, non-limiting implementation of the system 100, the charging station 114 can be transported to a location designated for training. The second induction coil 108 is connected to the second power supply 112. Electrical current is transferred from the second power supply 112 to the second induction coil 108. If the second power supply 112 is configured to provide alternating current, the electrical power is routed through the second induction coil 108. If the second power supply 112 is configured to provide direct current, the electrical power is routed through a power inverter 116 to convert the direct current to alternating current before being sent to the second induction coil 108.

The medical manikin simulator 106 is placed proximate the charging station 114, or the charging station 114 is placed proximate the manikin similar 106. This can include placing the first induction coil 102 proximate the second induction coil 108, or placing the second induction coil 108 proximate the first induction coil 102. For example, the medical manikin simulator 106 may be placed on the support structure 111 of the charging station 114 so that the first induction coil 102 of the medical manikin simulator 106 is proximate the second induction coil 108 of charging station 114. Electrical current passing through the second induction coil 108 generates electromotive forces in the first induction coil 102. With the first induction coil 102 being in an electrical circuit with the electrical circuitry 104, a voltage is generated by the first induction coil 102. The voltage is used to drive the electrical circuitry 104 or other components of the simulator 106.

In some embodiments, the first induction coil 102 is connected to the first power supply 110. The electrical power from the first induction coil 102 can be transmitted to the electrical circuitry 104 and/or the first power supply 110. The electrical current generated by the first induction coil 102 can be routed directly to the electrical circuitry 104 or routed through the first power supply 110 before being sent to the electrical circuitry 104. The electrical current from the first induction coil can be routed through a rectifier 118 to convert the electrical current, or at least a portion of it, to direct current before being transferred to the first power supply 110 and/or electrical circuitry 104.

In some embodiments, the medical manikin simulator 106 is placed proximate the second induction coil 108 by placing the simulator 106 on top of the charging station 114 so that the simulator 106 is in a first position. The position of the simulator 106 is changed from the first position to a second position without losing electrical power or interruption of the voltage used to drive the electrical circuitry 104 and without accommodating electrical power cables. The first position and the second position can be any one of a prone position, a supine position, a fetal position, or a recovery position, wherein the first position is different from the second position.

In some embodiment, an appendage of the medical manikin simulator 106 is moved without losing electrical power or interruption of the voltage used to drive the electrical circuitry 104 and without accommodating electrical power cables. In some embodiments, a medical trainee and/or a medical trainer moves about the simulator 106 without the simulator losing electrical power or interruption of the voltage used to drive the electrical circuitry 104 and without accommodating electrical power cables.

In some embodiments, the medical manikin simulator 106 is placed on top of a first charging station 114 so that the simulator 106 is located at a first training station and is being charged and/or powered by the first charging station 114. The simulator 106 is moved from the first training station to a second training station, the second training having a second charging station 114, so that the simulator 106 is charged and/or powered by the second charging station 114 without disconnecting and/or connecting electrical power cables.

It should be understood that modifications to the embodiments disclosed herein can be made to meet a particular set of design criteria. For instance, the number of or configuration of simulators 106, charging stations 114, first induction coils 102, second induction coils 108, and/or other components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

Therefore, it is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of apparatuses and methods of making and using the same have been discussed and illustrated herein, it is to be distinctly understood that the invention is not limited thereto but may be otherwise variously embodied and practiced within the scope of the following claims.

What is claimed is:

1. A medical simulator system, comprising:
a medical manikin simulator, comprising:
electrical circuitry configured to coordinate concerted motion and functionality of the medical manikin simulator;
a first power supply in electrical connection with the electrical circuitry; and
a first induction coil in an electrical circuit with the electrical circuitry and/or the first power supply; and
a second induction coil, separate from the medical manikin simulator, configured to receive electrical current from a second power supply;
wherein inductive coupling between the first induction coil and the second induction coil generates a voltage in the first induction coil to drive the electrical circuitry and/or charge the first power supply when the first induction coil is placed proximate the second induction coil.

2. The medical simulator system recited in claim 1, wherein the first power supply is a battery.

3. The medical simulator system recited in claim 1, wherein the second power supply is configured to provide direct current.

4. The medical simulator system recited in claim 3, further comprising a power inverter to convert the direct current to alternating current.

5. The medical simulator system recited in claim 1, wherein the second power supply is configured to provide alternating current.

6. The medical simulator system recited in claim 1, further comprising a rectifier to convert alternating current from the first induction coil to direct current.

7. The medical simulator system recited in claim 1, wherein the medical manikin simulator comprises a body portion having a torso, buttocks, a chest, and a back.

8. The medical simulator system recited in claim 7, wherein the first induction coil is located at or near the buttocks and/or the back.

9. The medical simulator recited in claim 1, wherein the second induction coil is providing within a mobile housing.

10. A medical simulator system kit, comprising:
at least one a medical manikin simulator, comprising: electrical circuitry configured to coordinate concerted motion and functionality of the medical manikin simulator; a first power supply in electrical connection with the electrical circuitry; and a first induction coil in an electrical circuit with the electrical circuitry and/or the first power supply; and
at least one charging station, comprising: a support structure; and a second induction coil provided within the support structure configured to receive electrical current from a second power supply;
wherein the at least one medical manikin simulator is configured to be supported by the at least one charging station so as to facilitate inductive coupling between the first induction coil and the second induction coil generating a voltage in the first induction coil to drive the electrical circuitry and/or charge the first power supply when the medical manikin simulator is supported by the at least one charging station.

11. The medical simulator system kit recited in claim 10, wherein the support structure comprises at least one of a mat, a table, and a workbench.

12. The medical simulator system kit recited in claim 10, wherein:
the at least one medical manikin simulator comprises a first medical manikin simulator and a second medical manikin simulator, the first medical manikin simulator being different from the second medical manikin simulator;
the at least one charting station is capable of facilitating inductive coupling between:
the first induction coil of the first medical manikin simulator and the second induction coil; and
the first induction coil of the second medical manikin simulator and the second induction coil.

13. A method of powering and/or charging a medical simulator, comprising:
placing a medical manikin simulator proximate a charging station, the medical manikin simulator comprising a first induction coil, a first power supply, and electrical circuitry, the charging station comprising a second induction coil configured to receive electrical current from a second power supply;
inducing inductive coupling between the first induction coil and the second induction coil to generate a voltage for driving the electrical circuitry and/or charging the first power supply.

14. The method recited in claim 13, further comprising placing the medical manikin simulator on top of the charging station.

15. The method recited in claim 14, further comprising:
placing the medical manikin simulator in a first position; and
moving the medical manikin simulator to a second position without interruption of the voltage used to drive the circuitry and without accommodating electrical power cables;
wherein each of the first position and the second position comprises any one of a prone position, a supine position, a fetal position, or a recovery position, wherein the first position is different from the second position.

16. The method recited in claim 14, further comprising moving at least one appendage of the medical manikin simulator without interruption of the voltage used to drive the circuitry and without accommodating electrical power cables.

17. The method recited in claim 14, further comprising a medical trainee and/or a medical trainer moving about the medical manikin simulator without interruption of the voltage used to drive the circuitry and without accommodating electrical power cables.

18. The method recited in claim 14, further comprising:
inducing inductive coupling between the first induction coil of the medical manikin simulator and a second induction coil of a first charging station;
moving the medical manikin simulator from the first charging station to a second charging station; and
inducing inductive coupling between the first induction coil of the medical manikin simulator and a second induction coil of the second charging station without disconnecting and/or connecting electrical power cables.
